(19) United States
(12) Patent Application Publication
(10) Pub. No.: US 2015/0359016 A1
(43) Pub. Date: Dec. 10, 2015

(54) APPARATUS AND METHOD TO ESTIMATE ROUND TRIP TIME VIA TRANSPORT CONTROL PROTOCOL SIGNALS

(71) Applicant: QUALCOMM Incorporated, San Diego, CA (US)

(72) Inventors: Peter Anthony Barany, San Diego, CA (US); Venkata Ramanan Venkatachalam Jayaraman, San Diego, CA (US); Rohit Kapoor, San Diego, CA (US); David William Craig, San Diego, CA (US); Andrew Llewellyn Martin, San Diego, CA (US)

(21) Appl. No.: 14/580,856

(22) Filed: Dec. 23, 2014

Related U.S. Application Data
(60) Provisional application No. 62/009,673, filed on Jun. 9, 2014.

(51) Int. Cl. H04W 76/02; H04W 24/08

(52) U.S. Cl. CPC H04W 76/02; H04W 24/08

(57) ABSTRACT

The disclosure provides a method, apparatus, and computer program product directed to a client estimation of round trip time via transport control protocol (TCP) signals over multiple radio access technologies. A TCP probe signal is transmitted to a server via a TCP connection, and an acknowledgment signal is received from the server via the TCP connection in response to the TCP probe signal. A round trip time is then estimated based on the acknowledgment signal.

### CROSS-REFERENCE TO RELATED APPLICATIONS

This application claims priority to and the benefit of provisional patent application No. 62/009,673, filed in the United States Patent and Trademark Office on Jun. 9, 2014, the entire content of which is incorporated herein by reference.

### TECHNICAL FIELD

Aspects of the present disclosure relate generally to wireless communication systems, and more particularly, to a client estimation of round trip time via transport control protocol signals over multiple radio access technologies.

### BACKGROUND

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). UMTS also supports enhanced 3 G data communications protocols, such as High Speed Packet Access (HSPA), which provides higher data transfer speeds and capacity to associated UMTS networks.

Generally, in order to determine how much data a client should request over a transport control protocol (TCP) connection where multiple TCP connections are established over a multiple radio access technology topography, it is desirable for the client to know the round trip time (RTT) between itself and a server over each radio access technology and its accompanying backbone/Internet routing path. Moreover, in order to request an optimal amount of data over each radio access technology, the client may multiply the RTT by the data rate to ascertain the Bandwidth-Delay Product (BDP). Accordingly, a mechanism is desired whereby a client can calculate a reliable RTT estimate between itself and a server on a frequent and regular basis.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

Aspects of the present disclosure provide methods, apparatuses, computer program products, and processing systems directed to a client estimation of round trip time via transport control protocol (TCP) signals over multiple radio access technologies. In one aspect, the disclosure provides a method that includes facilitating establishing a plurality of TCP connections across multiple radio access technologies between a client and a server such that each radio access technology is associated with at least one of the plurality of TCP connections. The method further includes selecting at least one TCP connection of the plurality of TCP connections for each of the multiple radio access technologies and transmitting at least one probe signal from the client to the server over the selected TCP connection. At least one acknowledgment signal is then received from the server via the selected TCP connection, such that the at least one acknowledgment signal is a TCP acknowledgment signal received in response to the at least one probe signal. The method concludes with an estimating of a round trip time between the client and the server based on the at least one probe signal and the at least one acknowledgment signal.

In another aspect, a device comprising a transmit circuit, a receive circuit, and an estimate circuit is disclosed. Here, the transmit circuit is configured to facilitate establishing a plurality of TCP connections across multiple radio access technologies between a client and a server such that each radio access technology is associated with at least one of the plurality of TCP connections. The transmit circuit further comprises a TCP selection subcircuit configured to select at least one TCP connection of the plurality of TCP connections for each of the multiple radio access technologies, wherein the transmit circuit is configured to transmit at least one probe signal from the client to the server over the selected TCP connection. The receive circuit is then configured to receive at least one acknowledgment signal at the client from the server via the selected TCP connection in response to the at least one probe signal, whereas the estimate circuit is configured to estimate a round trip time between the client and the server based on the at least one probe signal and the at least one acknowledgment signal.

In a further aspect, another device is disclosed. Here, the device comprises means for transmitting configured to facilitate establishing a plurality of TCP connections across multiple radio access technologies between a client and a server such that each radio access technology is associated with at least one of the plurality of TCP connections. In this implementation, at least one TCP connection of the plurality of TCP connections is selected for each of the multiple radio access technologies, wherein the means for transmitting is further configured to transmit at least one probe signal from the client to the server over the selected TCP connection. The device further comprises means for receiving at least one acknowledgment signal from the server via the selected TCP connection in response to the at least one probe signal, and means for estimating a round trip time between the client and the server based on the at least one probe signal and the at least one acknowledgment signal.

In yet another aspect, a non-transitory machine-readable storage medium having one or more instructions stored thereon is disclosed. Here, when executed by at least one processor, the one or more instructions cause the at least one processor to facilitate establishing a plurality of TCP connections across multiple radio access technologies between a client and a server such that each radio access technology is associated with at least one of the plurality of TCP connections. Instructions are also provided for causing the at least one processor to select at least one TCP connection of the plurality of TCP connections for each of the multiple radio access technologies, and transmit at least one probe signal from the client to the server over the selected TCP connection. The instructions further comprise instructions for causing the at least one processor to receive at least one acknowledgment signal at the client from the server over the selected TCP connection in response to the at least one probe signal, and estimate a round trip time between the client and the server based on the at least one probe signal and the at least one acknowledgment signal.

These and other disclosed aspects will become more fully understood upon a review of the detailed description, which follows. Other aspects, features, and aspects of the present invention will become apparent to those of ordinary skill in the art, upon reviewing the following description of specific, exemplary aspects of the present invention in conjunction with the accompanying figures. While features of the present invention may be discussed relative to certain aspects and figures below, all aspects of the present invention can include one or more of the advantageous features discussed herein. In other words, while one or more aspects may be discussed as having certain advantageous features, one or more of such features may also be used in accordance with the various aspects of the invention discussed herein. In similar fashion, while exemplary aspects may be discussed below as device, system, or method aspects it should be understood that such exemplary aspects can be implemented in various devices, systems, and methods.

### BRIEF DESCRIPTION OF THE DRAWINGS

FIG. 1 is a block diagram illustrating an example of a hardware implementation for a user equipment employing a processing system according to some aspects of the disclosure.

FIG. 2 is a flow chart illustrating an exemplary round trip time estimation procedure according to some aspects of the disclosure.

FIG. 3 is a block diagram illustrating exemplary transmitting components according to an aspect of the disclosure.

FIG. 4 is a timeline of exemplary probe signals in accordance with an aspect of the disclosure.

FIG. 5 is a call diagram of an exemplary probe signal procedure in accordance with an aspect of the disclosure.

FIG. 6 is a conceptual block diagram illustrating exemplary transport control protocol connections in accordance with a first aspect of the disclosure.

FIG. 7 is a conceptual block diagram illustrating exemplary transport control protocol connections in accordance with a second aspect of the disclosure.

FIG. 8 is a flow chart illustrating an exemplary probe signal transmission procedure according to some aspects of the disclosure.

FIG. 9 is a block diagram illustrating exemplary receiving components according to an aspect of the disclosure.

FIG. 10 is a flow chart illustrating an exemplary procedure for receiving acknowledgment signals in response to probe signal transmissions according to some aspects of the disclosure.

FIG. 11 is a block diagram illustrating exemplary estimating components according to an aspect of the disclosure.

FIG. 12 is a conceptual block diagram illustrating an exemplary client/server architecture in accordance with an aspect of the disclosure.

FIG. 13 is a conceptual block diagram illustrating an exemplary client/server architecture with a proxy server in accordance with a first aspect of the disclosure.

FIG. 14 is a conceptual block diagram illustrating an exemplary client/server architecture with a proxy server in accordance with a second aspect of the disclosure.

FIG. 15 is an exemplary timeline in which a timestamp option is utilized in accordance with an aspect of the disclosure.

FIG. 16 is a flow chart illustrating an exemplary procedure for estimating round trip time according to some aspects of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

The various aspects disclosed herein are generally directed to facilitating a client estimation of round trip time (RTT) between the client and a server. Particular aspects are disclosed for estimating such RTT via transport control protocol (TCP) signals disseminated over multiple radio access technologies. For instance, a configuration is contemplated in which the client performs RTT estimations based on TCP keepalive probes transmitted to a server in conjunction with TCP server responses to those probes, wherein aspects are disclosed for performing such estimations based on the probes and their corresponding responses either 1) after receiving an initial set of responses to an initial set of corresponding probes (e.g., immediately after, such as upon detecting that a predetermined number of acknowledgment signals have been received), or 2) after a TCP connection is established (e.g., immediately after, such as after the first few hundred milliseconds after the TCP connection is established). Within such configuration, it may be desirable to transmit TCP keepalive probes on a frequent and regular basis (e.g., with a period on the order of tens of milliseconds (ms)). In order to transmit such probes accordingly, aspects are disclosed for reconfiguring various TCP parameters. For example, because the two hour default value of tcp_keepidle (i.e., the length of time the TCP connection is kept active when no data is received) in current TCP implementations might be too long, aspects disclosed herein include shortening this value. It is also noted that, because the TCP clock (i.e., t_idle) counts the number of 500 ms clock ticks since a TCP segment was last received on the TCP connection, the smallest possible tcp_keepidle value allowed by current TCP implementations is 500 ms. As disclosed herein, however, this can be changed to a granularity of 1 ms, if a 1 ms system clock is used instead of the 500 ms t_idle clock.

Various aspects for selecting which TCP connection to utilize for estimating RTT are also contemplated. For instance, in a first implementation, the client establishes a single TCP connection for each radio access technology. Here, each of these single TCP connections are kept idle except for the sending of TCP keepalive probes by the client and the reception of acknowledgments (ACKs) from the server. Additionally, the client also establishes one or more TCP connections for each radio access technology (on an as needed basis), wherein these TCP connections are used for data and ACKs (i.e., the client requests data from the server on these TCP connections). In a second implementation, the client establishes two or more TCP connections for each radio access technology for data and ACKs (i.e., the client requests data from the server on these TCP connections), but when these TCP connections are idle (i.e., when no data is being received on them), TCP keepalive probes are sent in a round-robin fashion over these TCP connections.

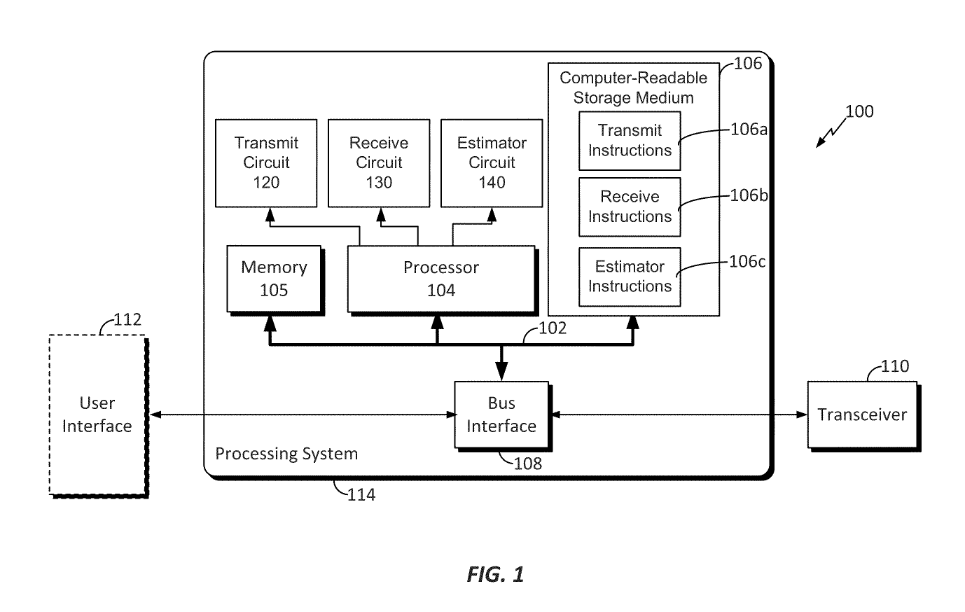

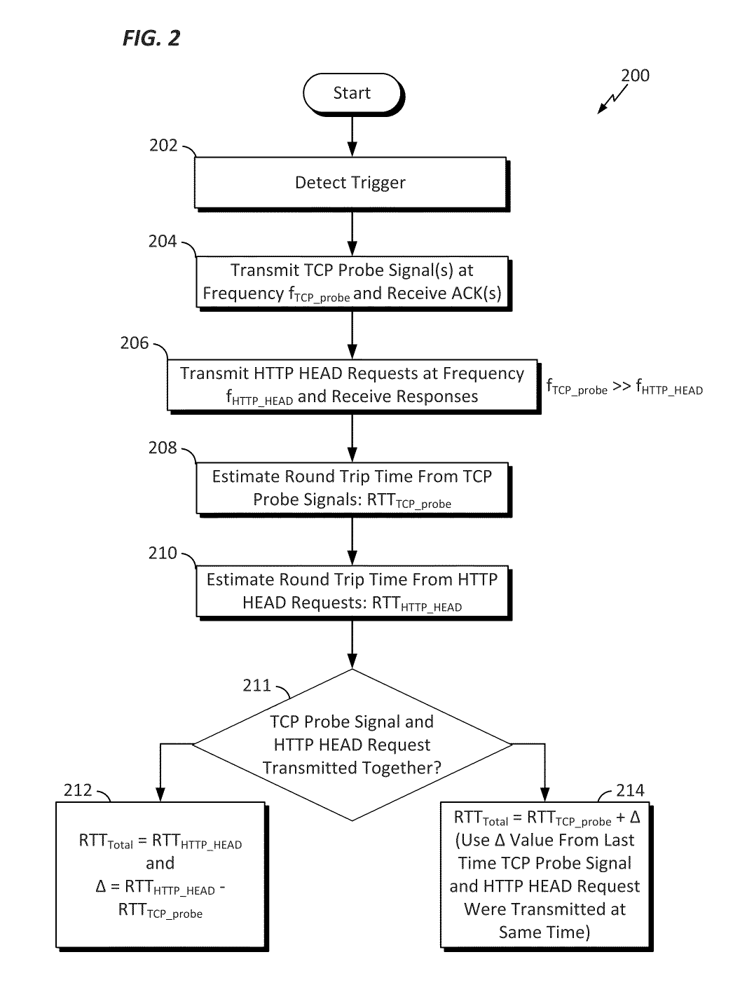

FIG. 1 is a conceptual diagram illustrating an example of a hardware implementation for a user equipment (UE) 100 employing a processing system 114, wherein UE 100 may be a UE as illustrated in or described with respect to any one or more of FIGS. 2-16. In accordance with various aspects of the disclosure, an element, or any portion of an element, or any combination of elements may be implemented with a processing system 114 that includes one or more processors 104. Examples of processors 104 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. That is, the processor 104, as utilized in UE 100, may be used to implement any one or more of the processes described below and illustrated in or described with respect to FIGS. 2-16.

In this example, the processing system 114 may be implemented with a bus architecture, represented generally by the bus 102. The bus 102 may include any number of interconnecting buses and bridges depending on the specific application of the processing system 114 and the overall design constraints. The bus 102 links together various circuits including one or more processors (represented generally by the processor 104), a memory 105, and computer-readable media (represented generally by the computer-readable medium 106). The bus 102 may also link various other circuits such as timing sources, peripherals, voltage regulators, and power management circuits, which are well known in the art, and therefore, will not be described any further. A bus interface 108 provides an interface between the bus 102 and a transceiver 110. The transceiver 110 provides a means for communicating with various other apparatus over a transmission medium. Depending upon the nature of the apparatus, a user interface 112 (e.g., keypad, display, speaker, microphone, joystick) may also be provided.

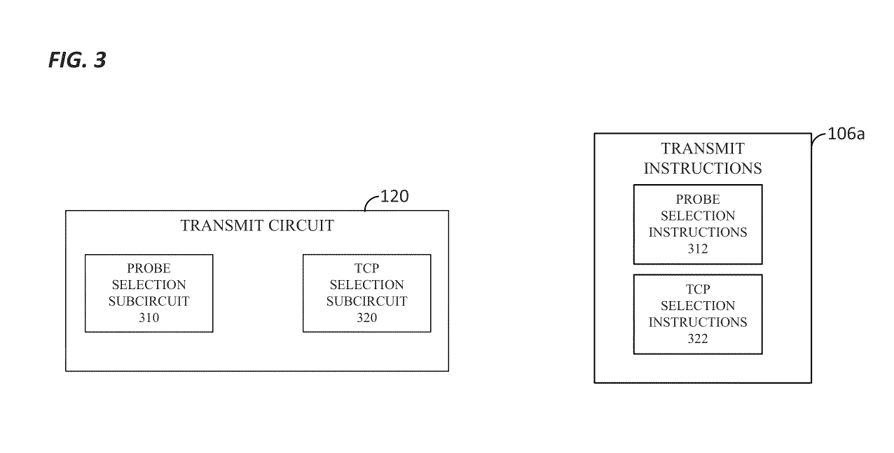

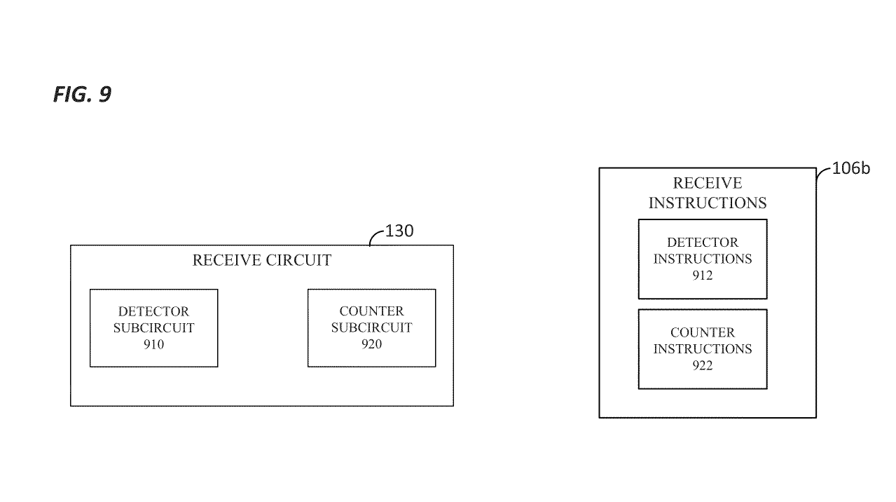

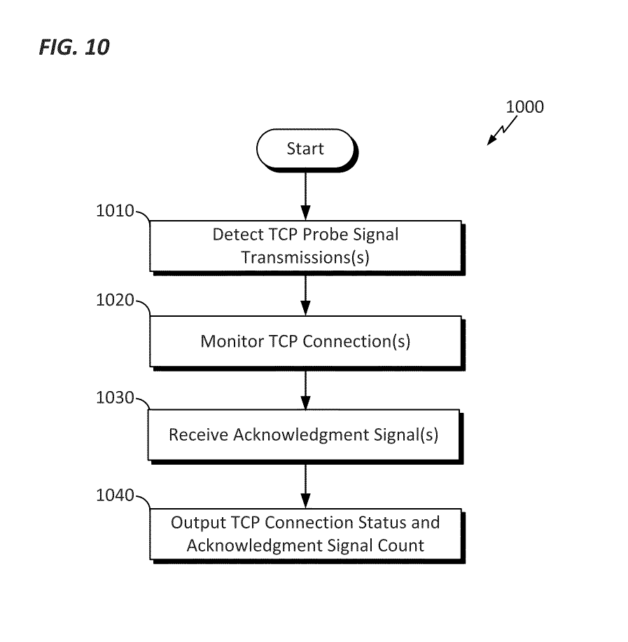

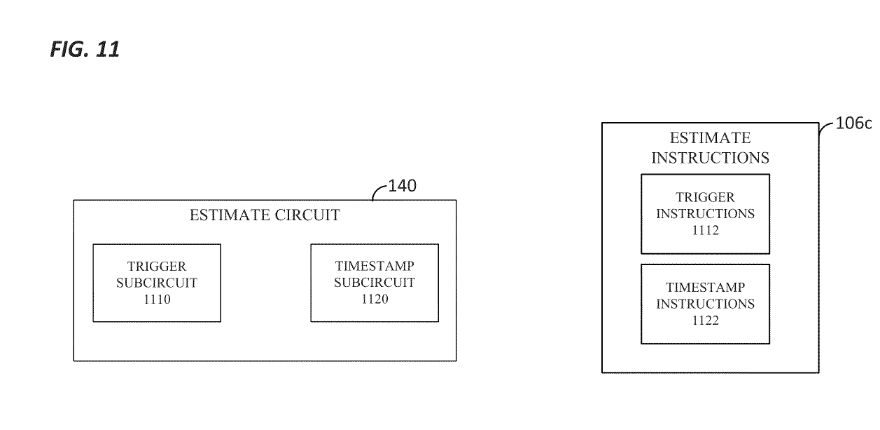

In an aspect of the disclosure, computer-readable medium 106 is configured to include various instructions 106a, 106b, and/or 106c to facilitate estimating RTTs between a client and server via TCP signals. In a similar aspect, such estimating can instead be implemented via hardware by coupling processor 104 to any of circuits 120, 130, and/or 140, as shown. Moreover, it is contemplated that the estimating may be performed by any combination of instructions 106a, 106b, and/or 106c, as well as any combination of circuits 120, 130, and/or 140. In a particular aspect of the disclosure, instructions 106a and circuit 120 are directed to facilitating establishing TCP connections across multiple radio access technologies between UE 100 and a server, and transmitting a TCP probe signal to the server over a selected TCP connection, which is discussed in further detail below with reference to FIGS. 3-8. UE 100 may then utilize instructions 106b and/or circuit 130 to receive a TCP acknowledgment (ACK) signal from the server, as discussed in further detail below with reference to FIGS. 9-10, and subsequently utilize instructions 106c and/or circuit 140 to estimate a round trip time between UE 100 and the server based on the received ACK signal, as discussed in further detail below with reference to FIGS. 11-16.

Referring back to the remaining elements of FIG. 1, it should be appreciated that processor 104 is responsible for managing the bus 102 and general processing, including the execution of software stored on the computer-readable medium 106. The software, when executed by the processor 104, causes the processing system 114 to perform the various functions described below for any particular apparatus. The computer-readable medium 106 may also be used for storing data that is manipulated by the processor 104 when executing software.

One or more processors 104 in the processing system may execute software.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 106. The computer-readable medium 106 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a transmission line, and any other suitable medium for transmitting software and/or instructions that may be accessed and read by a computer. The computer-readable medium 106 may reside in the processing system 114, external to the processing system 114, or distributed across multiple entities including the processing system 114. The computer-readable medium 106 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

Referring next to FIG. 2, a flowchart illustrating an exemplary round trip time estimation procedure in accordance with an aspect of the disclosure is provided. To this end, it is contemplated that procedure 200 may be performed at a UE, such as UE 100 of FIG. 1. In block 202, the UE detects a trigger for transmitting a TCP probe signal. As will be discussed in more detail below, such a trigger may leverage a TCP keepalive timer that exists in current TCP implementations. For example, the expiration of a TCP keepalive timer may be detected at block 202, which triggers the transmission of TCP probe signals at block 204.

For configurations where a proxy server is used (a situation which may not, in general, be known a priori) and/or where the processing delay at the origin server needs to be accounted for, it is contemplated that the disclosed RTT estimate calculation may account for both. Accordingly, at blocks 204 and 206 the UE transmits a TCP probe signal with frequency f_{TCP}_{_{—}}_{probe} and an HTTP HEAD request with frequency f_{HTTP}_{_{—}}_{HEAD}, where f_{TCP}_{_{—}}_{probe}>>f_{HTTP}_{_{—}}_{HEAD}, since in general HTTP HEAD requests need not be transmitted as frequently as TCP probe signals. Upon receiving TCP acknowledgments in block 204, the UE may use those acknowledgments to estimate the RTT (viz. RTT_{TCP}_{_{—}}_{probe}) between the UE and the proxy server (if one is present) or origin server at block 208. Upon receiving HTTP HEAD request responses in block 206, the UE may use those HTTP responses to estimate the RTT (viz. RTT_{HTTP}_{_{—}}_{HEAD}) between the UE and the origin server at block 210. Upon estimating both RTT_{TCP}_{_{—}}_{probe} and RTT_{HTTP}_{_{—}}_{HEAD} in blocks 208 and 210, procedure 200 proceeds to block 211 where the UE determines whether the TCP probe signal and HTTP HEAD request were transmitted together. If the TCP probe signal and HTTP HEAD request are transmitted at the same time as in block 212, then RTT_{Total}=RTT_{HTTP}_{_{—}}_{HEAD} and a delta between RTT_{HTTP}_{_{—}}_{HEAD} and RTT_{TCP}_{_{—}}_{probe} is calculated for future reference, where Δ=RTT_{HTTP}_{_{—}}_{HEAD}−RTT_{TCP}_{_{—}}_{probe}. However, if the TCP probe signal is not transmitted concurrently with the HTTP HEAD request, as in block 214, then RTT_{Total}=RTT_{TCP}_{_{—}}_{probe}+Δ, where the value for Δ is from the last time that the TCP probe signal and HTTP HEAD request were transmitted at the same time.

### Transmitting Component

Various aspects directed to transmitting TCP probe signals disclosed herein are now discussed with reference to FIGS. 3-8. For instance, as illustrated in FIG. 3, each of transmit circuit 120 and transmit instructions 106a may facilitate such transmission via any of a plurality of subcomponents. For example, transmit circuit 120 may comprise probe selection sub-circuit 310 and TCP selection sub-circuit 320, whereas transmit instructions 106a may comprise probe selection instructions 312 and TCP selection instructions 322.

In a particular aspect of the disclosure, it is contemplated that either of probe selection sub-circuit 310 and/or probe selection instructions 312 may be configured for selecting a probe signal type associated with each TCP probe signal transmission. For instance, the TCP probe signal may be either a TCP keepalive signal or an HTTP HEAD request. Indeed, as discussed in further detail below, it is further contemplated that transmit circuit 120 and/or transmit instructions 106a may be configured to transmit a first probe signal of a first type and subsequently transmit a second probe signal of a second type. For example, probe selection sub-circuit 310 and/or probe selection instructions 312 may be configured to select a TCP keepalive signal for the first probe signal, and probe selection sub-circuit 310 and/or probe selection instructions 312 may be configured to select an HTTP HEAD request for the second probe signal.

### TCP Keepalive Probe Signals

As mentioned above, particular aspects disclosed herein utilize TCP keepalive signals to facilitate performing RTT estimate calculations. To this end, although TCP keepalive signals are not currently part of the TCP specification, most implementations support TCP keepalive functionality. It should be noted that either end of a TCP connection may send TCP keepalive probes, which are turned off by default. It should be further noted that a TCP keepalive probe may be an empty (or 1 byte) TCP segment with the ACK bit set and with the sequence number (SN) equal to one less than the next sequence number to be sent. Because this sequence number has already been acknowledged by the receiving peer, the arriving TCP segment simply elicits an ACK that is used to determine whether the connection is still operating. If there is no activity on the TCP connection for some period of time, the host with TCP keepalive enabled sends a TCP keepalive probe to its peer. If no response is received, the TCP keepalive probe is retransmitted periodically until a maximum number of TCP keepalive probes has been reached. If this occurs, the peer's system is deemed unreachable and the TCP connection is terminated.

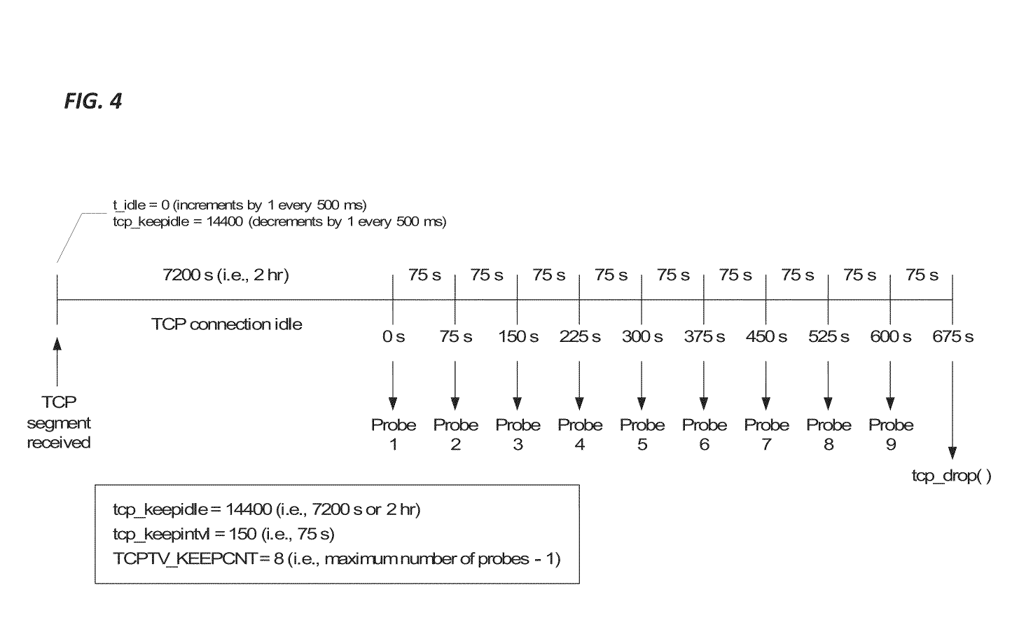

Referring next to FIG. 4, a timeline of exemplary TCP keepalive probe transmissions is provided in accordance with an aspect of the disclosure. As illustrated, TCP keepalive probes are transmitted according to various parameters. For instance, the “tcp_keepidle” value is a configurable parameter that specifies a length of time a TCP connection is kept active. Although this value is defined in ½ second units (i.e., 500 ms) and currently defaults to 14400 (i.e., 7200 seconds or 2 hours), it is contemplated that this value can be tied to a 1 ms system clock rather than a 500 ms clock. For some implementations, it is also contemplated that tcp_keepidle is configured to change dynamically (e.g., based upon how frequently the RTT measurements change) while the TCP connection is established.

Another configurable parameter illustrated in FIG. 4 is the “tcp_keepintvl” value, which specifies the interval between TCP keepalive probes sent to validate a TCP connection when no response is received from a TCP keepalive probe. This value is also defined in ½ second units (i.e., 500 ms), and defaults to 150 (i.e., 75 seconds). However, similar to the tcp_keepidle parameter, it is contemplated that the tcp_keepintvl parameter can be tied to a 1 ms system clock rather than a 500 ms clock.

A “tcptv_keepcnt” value is also configurable, wherein these values specify the maximum number of TCP keepalive probes—1 that a TCP connection will send to another host waiting for a response. In FIG. 4, because the maximum number of probes shown is nine, the value of tcptv_keepcnt for this particular example is eight.

Another TCP keepalive parameter illustrated in FIG. 4 is the “t_idle” value, which is a non-configurable parameter. This parameter counts the number of 500 ms clock ticks since a TCP segment was last received on the TCP connection. However, similar to the tcp_keepidle and tcp_keepintvl parameters, it is contemplated that the t_idle parameter can be tied to a 1 ms system clock rather than a 500 ms clock. Upon receiving either a TCP data segment or an ACK, the t_idle value is then cleared (i.e., t_idle=0).

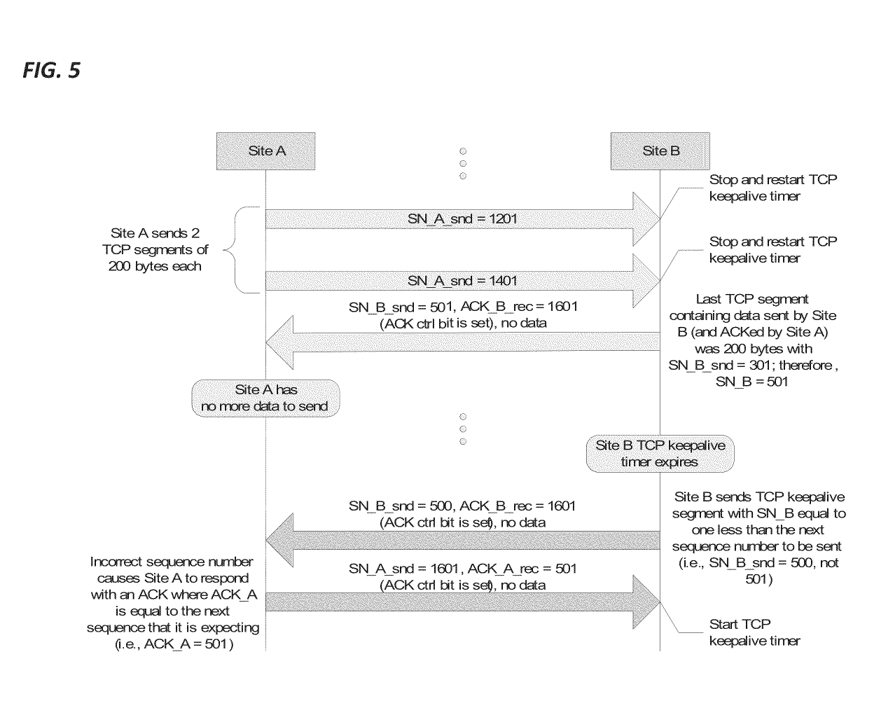

Referring next to FIG. 5, a call diagram of an exemplary probe signal procedure is provided in accordance with an aspect of the disclosure. As illustrated, for this particular example, the procedure begins with Site A transmitting two TCP segments of 200 bytes each to Site B, which stops and restarts the TCP keepalive timer on Site B. At some point after Site A no longer has data to transmit, the TCP keepalive timer on Site B expires. Site B then sends a TCP keepalive segment to Site A with a sequence number (SN) equal to one less than the next sequence number to be sent, as shown. Upon detecting that this is an incorrect sequence number, Site A responds by transmitting an ACK equal to the next expected sequence number to Site B, which restarts the TCP keepalive timer in Site B.

### Selection of TCP Connection

It should be appreciated that multiple TCP connections may exist between a UE client and a server at any given time. Accordingly, in a particular aspect of the disclosure, either of TCP selection sub-circuit 320 and/or TCP selection instructions 322 may be configured to select a particular TCP connection from a plurality of TCP connections across multiple radio access technologies, wherein the selected TCP connection is an idle TCP connection. RTT estimates are then calculated as a function of TCP probe signals transmitted via the selected TCP connection.

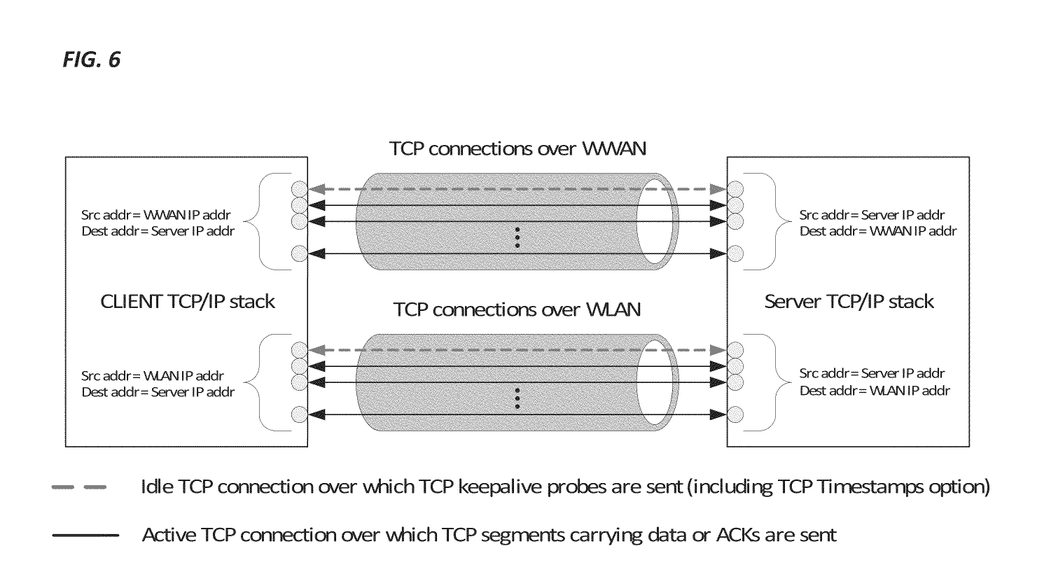

Various aspects for selecting which TCP connection to utilize for estimating RTT are contemplated. A first implementation is illustrated in FIG. 6, wherein the UE client establishes a single TCP connection for each radio access technology. For this implementation, the selecting may thus comprise respectively establishing a single TCP connection for each of the multiple radio access technologies and selecting a particular single TCP connection as the selected TCP connection. Subsequent probe signals and corresponding acknowledgment signals may then be communicated via the particular single TCP connection when the particular single TCP connection is idle. Moreover, each of these single TCP connections are kept idle except for the sending of TCP keepalive probes by the client and the reception of acknowledgments (ACKs) from the server. As mentioned previously, in order to account for both the presence of a proxy server (a situation which may not, in general, be known a priori) and the processing delay at the origin server, the client may also send HTTP HEAD requests at a frequency much less than that of the TCP keepalive probes. Additionally, the client also establishes one or more TCP connections for each radio access technology (on an as needed basis), wherein these TCP connections are used for data and ACKs (i.e., the client requests data from the server on these TCP connections).

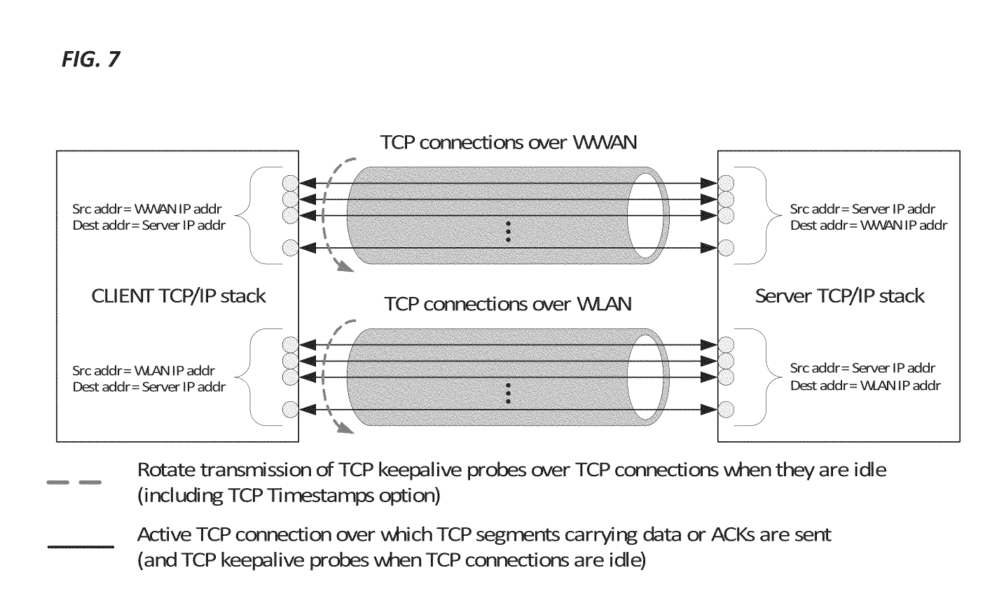

A second implementation is illustrated in FIG. 7. For this implementation, the selecting may comprise respectively establishing at least two TCP connections for each of the multiple radio access technologies and rotating the selected TCP connection amongst the plurality of TCP connections. Subsequent probe signals and corresponding acknowledgment signals may then be respectively communicated via the rotated selected TCP connection. Here, the client may thus establish two or more TCP connections for each radio access technology for data and ACKs (i.e., the client requests data from the server on these TCP connections). However, when these TCP connections are idle (i.e., when no data is being received on them), the TCP keepalive probes are sent in a round-robin fashion over these TCP connections. As mentioned previously, in order to account for both the presence of a proxy server (a situation which may not, in general, be known a priori) and the processing delay at the origin server, the client may also send HTTP HEAD requests at a frequency much less than that of the TCP keepalive probes.

### Exemplary Probe Signal Transmission Procedure

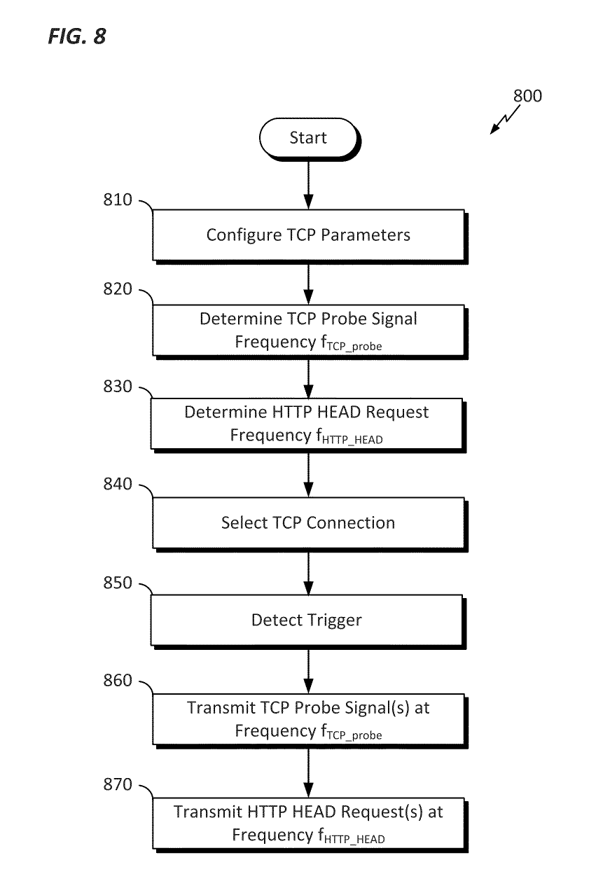

Referring next to FIG. 8, a flowchart illustrating an exemplary probe signal transmission procedure in accordance with an aspect of the disclosure is provided. As illustrated, procedure 800 comprises a series of acts that facilitate probe signal transmissions, wherein such acts may be performed in conjunction with other aspects disclosed herein. For instance, with reference to FIG. 2, it is contemplated that block 204 of procedure 200 may comprise various aspects of procedure 800. To this end, it is thus further contemplated that procedure 800 may be performed at a UE, such as UE 100 of FIG. 1, by any combination of hardware and/or software included therein. For instance, procedure 800 may be performed by any combination of transmit circuit 120 and/or transmit instructions 106a.

As illustrated, procedure 800 begins at block 810 where various TCP parameters are configured. As mentioned previously, such configuration may include configuring values for any of tcp_keepidle, tcp_keepintvl, tcptv_keepcnt, and/or t_idle. Procedure 800 then continues to blocks 820 and 830 where the UE respectively determines the desired TCP probe signal frequency f_{TCP}_{_{—}}_{probe} and desired HTTP HEAD request frequency f_{HTTP}_{_{—}}_{HEAD}. In a particular aspect of the disclosure, because HTTP HEAD request transmissions are generally not needed as frequently as TCP probe signals, it is contemplated that f_{TCP}_{_{—}}_{probe} may be much larger than f_{HTTP}_{_{—}}_{HEAD}. For instance, in an exemplary implementation, f_{TCP}_{_{—}}_{probe} is approximately ten times larger than f_{HTTP}_{_{—}}_{HEAD} such that if TCP keepalive probes are sent every 50 ms then HTTP HEAD requests are sent every 500 ms.

In a further aspect of the disclosure, the UE is also configured to select the particular TCP connection(s) to use for transmitting TCP probe signals. Here, it is contemplated that such selection is performed at block 840, wherein the TCP connection may be selected according to any of a plurality of selection algorithms. For instance, as described with reference to FIG. 6, the UE client may establish a single TCP connection for each radio access technology, wherein each of these single TCP connections are kept idle except for the sending of TCP keepalive probes by the client and the reception of acknowledgments (ACKs) from the server. Alternatively, as described with reference to FIG. 7, the UE client may establish two or more TCP connections for each radio access technology for data and ACKs (i.e., the client requests data from the server on these TCP connections), wherein the TCP keepalive probes are sent in a round-robin fashion over these TCP connections when the TCP connections are idle (i.e., when no data is being received on them).

After the UE has been properly configured, procedure 800 then proceeds to block 850 where the UE detects a trigger for transmitting a TCP probe signal. As previously mentioned, such a trigger may leverage a TCP keepalive timer that exists in current TCP implementations. For instance, the expiration of a TCP keepalive timer may be detected at block 850, which triggers the transmission of TCP probe signals at a frequency of f_{TCP}_{_{—}}_{probe} at block 860 and the transmission of HTTP HEAD requests at a frequency of f_{HTTP}_{_{—}}_{HEAD} at block 870. Here, the respective transmissions may thus comprise determining a frequency of the keepalive signal f_{TCP}_{_{—}}_{probe} and a frequency of the HTTP HEAD request f_{HTTP}_{_{—}}_{HEAD}. Also, as stated previously, such determination may include determining that the frequency of the keepalive signal f_{TCP}_{_{—}}_{probe} is larger than the frequency of the HTTP HEAD request.

### Receiving Component

Various aspects directed to receiving acknowledgment signals in response to probe signal transmissions disclosed herein are now discussed with reference to FIGS. 9-10. For instance, as illustrated in FIG. 9, each of receive circuit 130 and receive instructions 106b may facilitate receiving such acknowledgments via any of a plurality of subcomponents. For example, receive circuit 130 may comprise detector sub-circuit 910 and counter sub-circuit 920, whereas receive instructions 106b may comprise detector instructions 912 and counter instructions 922.

In a particular aspect of the disclosure, it is contemplated that RTT estimates may be performed after a triggering event has been detected, wherein receive circuit 130 and/or receive instructions 106b may be configured to facilitate such detection. For instance, it may be desirable to perform RTT estimates immediately upon establishing a TCP connection. To facilitate implementing such a trigger, either of detector sub-circuit 910 and/or detector instructions 912 may be configured to detect whether at least one TCP connection has been established between the UE and a server. Alternatively, rather than performing RTT estimates immediately upon establishing a TCP connection, it may be desirable to wait until a threshold number of acknowledgment signals have been received in response to probe signals transmitted by the UE. To facilitate implementing this type of trigger, either of counter sub-circuit 920 and/or counter instructions 922 may be configured to count the number of acknowledgment signals received by the UE.

### Exemplary Procedure for Receiving Acknowledgment Signals

Referring next to FIG. 10, a flowchart illustrating an exemplary procedure for receiving acknowledgment signals in response to probe signal transmissions in accordance with an aspect of the disclosure is provided. As illustrated, procedure 1000 comprises a series of acts that facilitate receiving probe signal acknowledgments, wherein such acts may be performed in conjunction with other aspects disclosed herein. For instance, with reference to FIG. 2, it is contemplated that block 204 of procedure 200 may comprise various aspects of procedure 1000. To this end, it is contemplated that procedure 1000 may be performed at a UE, such as UE 100 of FIG. 1, by any combination of hardware and/or software included therein. For instance, procedure 1000 may be performed by any combination of receive circuit 130 and/or receive instructions 106b.

As illustrated, procedure 1000 begins at block 1010 where receive circuit 130 and/or receive instructions 106b detect that TCP probe signals have been transmitted. Such detection may be facilitated via hardware by connecting transmit circuit 120 and receive circuit 130 and/or via software by configuring receive instructions 106b to receive a value from transmit instructions 106a indicating that a TCP probe signal has been transmitted. Upon detecting that a TCP probe signal has been transmitted, the UE may then begin monitoring the status of its TCP connection(s) with a server at block 1020. As previously mentioned, because it may be desirable to perform RTT estimates immediately upon establishing a TCP connection, either of detector sub-circuit 910 and/or detector instructions 912 may be used to monitor TCP connections at block 1020. Procedure 1000 then continues to block 1030 where acknowledgment signals are received in response to the TCP probe signal transmissions. In a particular aspect of the disclosure, either of counter sub-circuit 920 and/or counter instructions 922 may be used to count the number of acknowledgment signals received by the UE at block 1030. Procedure 1000 then concludes at block 1040 where the TCP connection status ascertained at block 1020, and a count of the number of acknowledgment signals received by the UE at block 1030, are output. Here, because such output may be used as a trigger to begin performing RTT estimates, it is contemplated that this output may be provided either via hardware (e.g., by connecting receive circuit 130 and estimate circuit 140) and/or via software (e.g., by configuring receive instructions 106b to transmit values to estimate instructions 106c representing such output).

### Estimating Component

Various aspects directed to estimating round trip time disclosed herein are now discussed with reference to FIGS. 11-16. For instance, as illustrated in FIG. 11, each of estimate circuit 140 and estimate instructions 106c may facilitate such estimation via any of a plurality of subcomponents. For example, estimate circuit 140 may comprise trigger sub-circuit 1110 and timestamp sub-circuit 1120, whereas estimate instructions 106c may comprise trigger instructions 1112 and timestamp instructions 1122.

### Exemplary RTT Estimate Calculations

As previously mentioned, it may be desirable to have RTT estimates performed after a triggering event has been detected. To facilitate such triggering, it is contemplated that either of trigger sub-circuit 1110 and/or trigger instructions 1112 may be included, wherein either of trigger sub-circuit 1110 and/or trigger instructions 1112 may be configured to operate in conjunction with subcomponents of receive circuit 130 and/or receive instructions 106b, as desired. For instance, if the desired trigger is an established TCP connection, either of trigger sub-circuit 1110 and/or trigger instructions 1112 may be configured to operate in conjunction with detector sub-circuit 910 and/or detector instructions 912, wherein an RTT estimation is triggered upon detecting that a TCP connection has been established. Alternatively, if the desired trigger is a threshold number of acknowledgments, either of trigger sub-circuit 1110 and/or trigger instructions 1112 may be configured to operate in conjunction with counter sub-circuit 920 and/or counter instructions 922, wherein an RTT estimation is triggered upon detecting that a predetermined number of acknowledgment signals have been received.

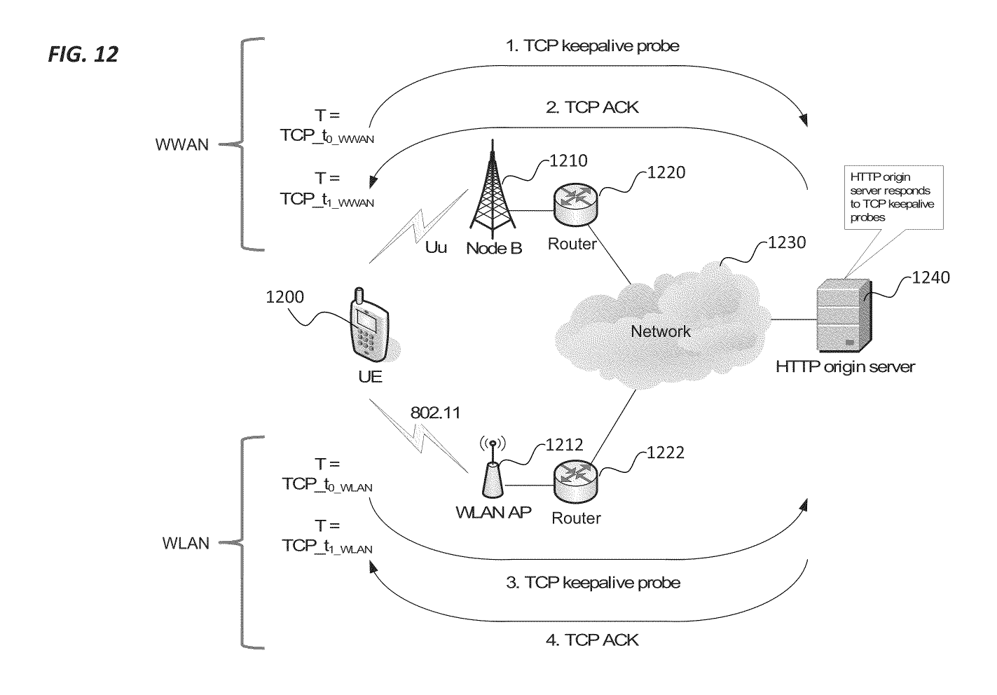

As indicated above, various aspects disclosed herein are directed to having a client perform RTT estimations based on TCP keepalive probes transmitted to a server in conjunction with TCP server responses to those probes. Referring next to FIG. 12, a conceptual block diagram illustrating an exemplary client/server architecture without a proxy server (a situation which may not, in general, be known a priori) is provided in accordance with aspects of the disclosure. For instance, in a particular aspect, the architecture illustrated in FIG. 12 may be configured to facilitate estimating RTTs at a UE according to procedure 200 illustrated in FIG. 2 based on ACKs received in response to probe signals transmitted from the UE. As illustrated in FIG. 12, it is contemplated that a UE 1200 client may be configured to perform RTT estimate calculations in accordance with aspects disclosed herein for wireless wide area network (WWAN) TCP connections and/or wireless local area network (WLAN) TCP connections. In both procedures, a TCP keepalive probe is sent to an HTTP origin server 1240, which responds with a TCP ACK, as shown. For instance, with respect to WWAN TCP connections, TCP keepalive probes and corresponding TCP ACKs may be communicated between the UE 1200 and the HTTP origin server 1240 via Node B 1210, router 1220, and network 1230, as shown. Similarly, with respect to WLAN TCP connections, TCP keepalive probes and corresponding TCP ACKs may be communicated between the UE 1200 and the HTTP origin server 1240 via WLAN access point 1212, router 1222, and network 1230, as shown. Upon receiving the TCP ACK from the HTTP origin server 1240, the UE 1200 then calculates an RTT estimate based on one of two equations. For WWAN TCP connections, the UE 1200 may thus determine RTT by subtracting the time at which the initial TCP probe was sent, TCP_t₀_{_{—WWAN}}, from the time at which a TCP ACK is received, TCP_t₁_{_{—}}_{WWAN}. Moreover, the UE 1200 may calculate an RTT estimate by using:

RTT_WWAN_{TCP}_{_{—}}_{probe}=TCP_{—}t₁_{_{—}}_{WWAN}−TCP_{—}t₀_{_{—}}_{WWAN} (1)

For WLAN TCP connections, however, the UE 1200 uses:

RTT_WLAN_{TCP}_{_{—}}_{probe}=TCP_{—}t₁_{_{—}}_{WLAN}−TCP_{—}t₀_{_{—}}_{WLAN} (2)

Note that equations (1) and (2) above do not account for the processing delay at the origin server (i.e., HTTP HEAD requests are not transmitted by the UE 1200).

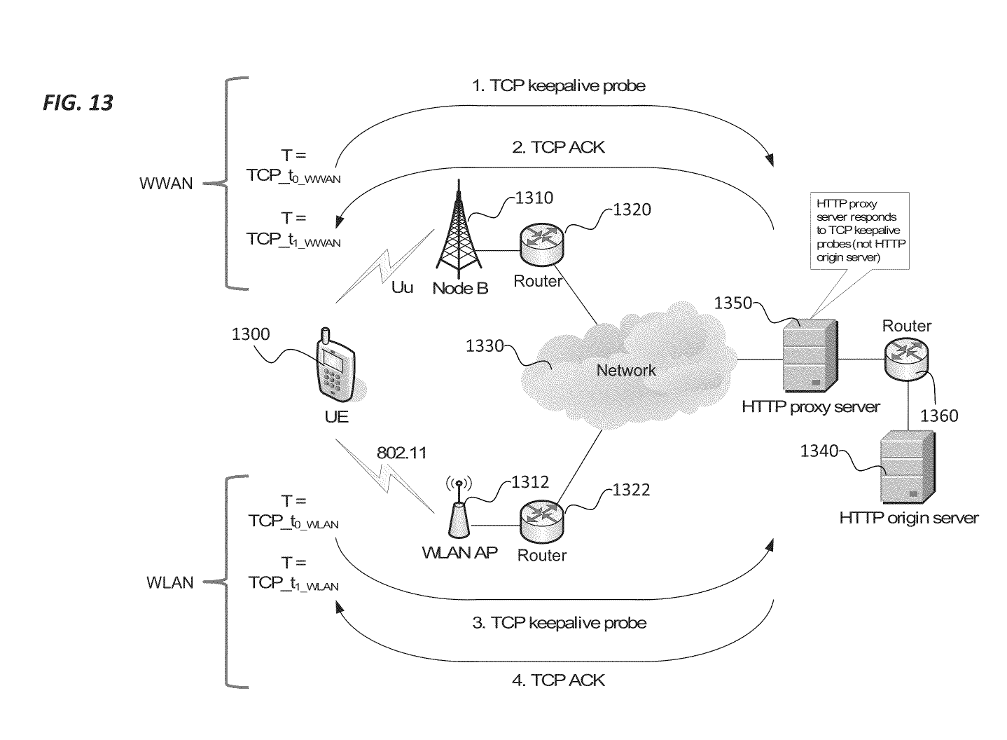

Referring next to FIG. 13, a conceptual block diagram illustrating an exemplary client/server architecture with a proxy server (a situation which may not, in general, be known a priori) is provided in accordance with aspects of the disclosure. In a particular aspect, similar to the architecture illustrated in FIG. 12, it is contemplated that the architecture illustrated in FIG. 13 may be configured to facilitate estimating RTTs at a UE according to procedure 200 illustrated in FIG. 2 based on ACKs received in response to probe signal transmissions. Here, however, it is contemplated that a UE 1300 client may be configured to perform RTT estimate calculations for WWAN TCP connections and/or WLAN TCP connections, wherein TCP keepalive probes and corresponding TCP ACKs may be communicated between the UE 1300 and the HTTP origin server 1340 via Node B 1310, router 1320, network 1330, proxy server 1350, and router 1360, for WWAN TCP connections, as shown, and wherein probes and corresponding ACKs for WLAN TCP connections may be communicated between the UE 1300 and the HTTP origin server 1340 via WLAN access point 1312, router 1322, network 1330, proxy server 1350, and router 1360. The accuracy of the RTT estimate calculated by the UE 1300 may depend on whether the delay between the proxy server 1350 and the origin server 1340 is small relative to the delay between the UE 1300 and proxy server 1350. If the delay between the proxy server 1350 and the origin server 1340 is relatively small (e.g., less than 2 ms), the total RTT estimate may be approximated to be the RTT between the UE 1300 and the proxy server 1350. Namely, for WWAN TCP connections:

RTT_WWAN_{Total}≈RTT_WWAN_{TCP}_{_{—}}_{probe} (3)

where,

RTT_WWAN_{TCP}_{_{—}}_{probe}=TCP_{—}t₁_{_{—}}_{WWAN}−TCP_{—}t₀_{_{—}}_{WWAN} (4)

Similarly, for WLAN TCP connections:

RTT_WLAN_{Total}≈RTT_WLAN_{TCP}_{_{—}}_{probe} (5)

where,

RTT_WLAN_{TCP}_{_{—}}_{probe}=TCP_{—}t₁_{_{—}}_{WLAN}−TCP_{—}t₀_{_{—}}_{WLAN} (4)

Note that equations (3) through (6) above do not account for the processing delay at the origin server (i.e., HTTP HEAD requests are not transmitted by the UE 1300).

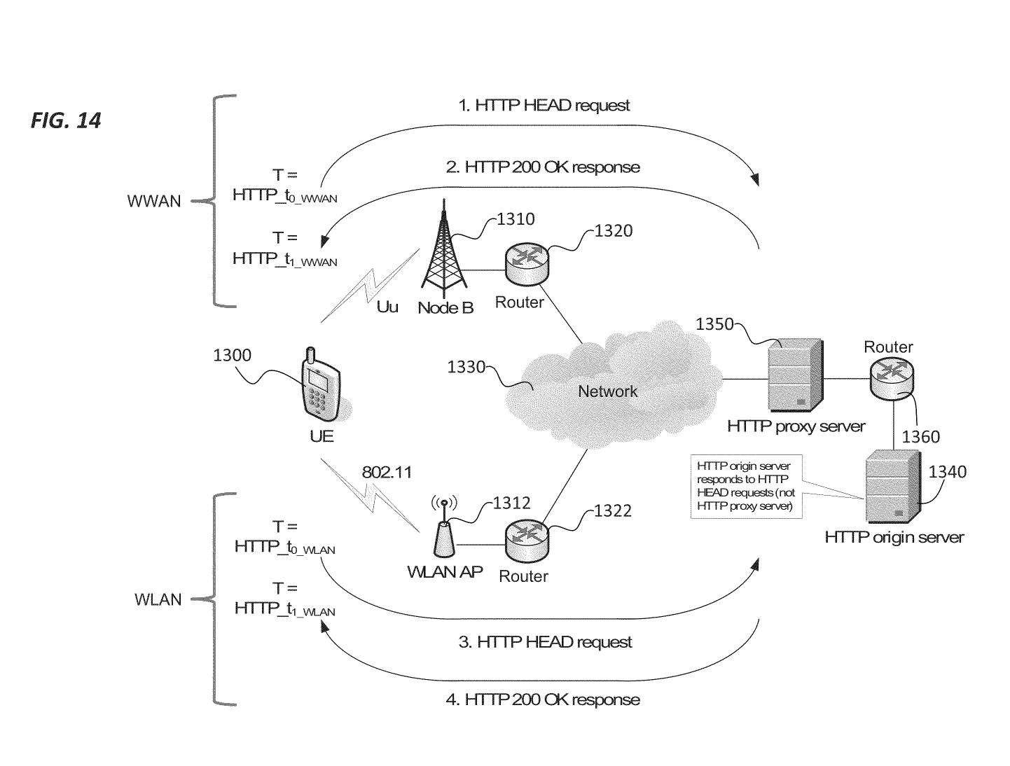

If the delay is deemed non-negligible though (i.e., if RTT_WWAN_{TCP}_{_{—}}_{probe} or RTT_WLAN_{TCP}_{_{—}}_{probe}>threshold (e.g., 10 ms)) (a situation which may not, in general, be known a priori), the UE 1300 periodically transmits HTTP HEAD requests to the proxy server 1350 in addition to the probe signals, as illustrated in FIG. 14. In a particular implementation, the UE 1300 sends TCP keepalive probes periodically with a frequency higher than HTTP HEAD requests by an order of magnitude (e.g., send TCP keepalive probes every 50 ms and send HTTP HEAD requests every 500 ms). The UE 1300 then estimates the total RTT based on received server responses, wherein the proxy server 1350 provides the UE 1300 with responses to the probe signals, and wherein the origin server 1340 provides the UE 1300 with responses to the HTTP head requests via the proxy server 1350. The UE 1300 may thus approximate RTT by subtracting the time at which the initial HTTP HEAD request was sent, HTTP_t₀_{_{—}}_{WWAN/WLAN}, from the time at which a response to the HTTP HEAD request is received, HTTP_t_{1 WWAN/WLAN}. Namely, the UE 1300 estimates the total RTT using HTTP HEAD requests every 500 ms according to:

RTT_WWAN_{Total}=RTT_WWAN_{HTTP}_{_{—}}_{HEAD}=HTTP_{—}t₁_{_{—}}_{WWAN}−HTTP_{—}t₀_{_{—}}_{WWAN} (7)

RTT_WLAN_{Total}=RTT_WLAN_{HTTP}_{_{—}}_{HEAD}=HTTP_{—}t₁_{_{—}}_{WLAN}−HTTP_{—}t₀_{_{—}}_{WLAN} (8)

The RTT between the proxy server 1350 and the origin server 1340 may then be estimated as follows:

RTT_WWAN_{proxy-origin}≈RTT_WWAN_{HTTP}_{_{—}}_{HEAD}−RTT_WWAN_{TCP}_{_{—}}_{probe} (9)

RTT_WLAN_{proxy-origin}≈RTT_WLAN_{HTTP}_{_{—}}_{HEAD}−RTT_WLAN_{TCP}_{_{—}}_{probe} (10)

Then, when only TCP keepalive probes are sent (i.e., at a higher frequency than HTTP HEAD requests), the total RTT is estimated as follows:

RTT_WWAN_{Total}≈RTT_WWAN_{TCP}_{_{—}}_{probe}+RTT_WWAN_{probe-origin} (11)

RTT_WLAN_{Total}≈RTT_WLAN_{TCP}_{_{—}}_{probe}+RTT_WLAN_{probe-origin} (11)

where the values for RTT_WWAN_{proxy-origin} and RTT_WLAN_{proxy-origin} are from the last time that the TCP probe signal and HTTP HEAD request were transmitted at the same time.
Note that equations (7) through (12) above account for both the presence of a proxy server 1350 and the processing delay at the origin server 1340 since HTTP HEAD requests are transmitted by the UE 1300.

### Timestamp Option

As previously mentioned, it is contemplated that TCP keepalive signals may be used in conjunction with a TCP timestamps option to improve RTT estimate accuracy. Accordingly, to facilitate such implementation, it is contemplated that either of timestamp sub-circuit 1120 and/or timestamp instructions 1122 may be included and configured to ascertain timestamp data from a TCP timestamps option, wherein RTT estimates are determined as a function of the timestamp data. To this end, it should be noted that a TCP timestamps option is defined in Request for Comments (RFC) 1323, Section 3.2, and may be sent in an initial synchronize (SYN) segment (i.e., SYN bit is set and ACK bit is not set). The TCP timestamps option is also defined to include various fields. For instance, a Timestamp Value field (TSval) includes the current timestamp clock value of the TCP sending this option. A Timestamp Echo Reply field (TSecr) is also included, which is only valid if the ACK bit is set in the TCP header. If it is valid, it echoes the timestamp value that was sent by the remote TCP in the TSval field of the timestamps option.

For purposes of estimating RTT, particular TCP timestamps option implementation specific parameters which are not included in the actual TCP timestamps option should be noted. For instance, the “tcp_now” value specifies the timestamp clock, wherein this value is initialized to zero when the kernel is initialized and incremented by one every 500 ms. For some implementations, however, it is contemplated that a 1 ms system clock may be used instead of a 500 ms clock.

Various other TCP timestamps option implementation specific parameters are also used but not included in the actual TCP timestamps option itself. For instance, the “ts_recent” value specifies a copy of the most recent valid timestamp from the other end (i.e., ts_recent=TSval), wherein TSecr subsequently equals ts_recent in the corresponding ACK. Values for “ts_val” and “ts_ecr” are also included, wherein ts_val specifies the timestamp sent by the other end with its TCP data segment (i.e., TSval), and wherein ts_ecr specifies the timestamp from the TCP data segment that is being acknowledged by the received ACK (i.e., TSecr).

By utilizing a TCP timestamp option, the RTT of a transmitted TCP data segment and its ACK may be calculated as:

RTT=tcp_now−ts_ecr (12)

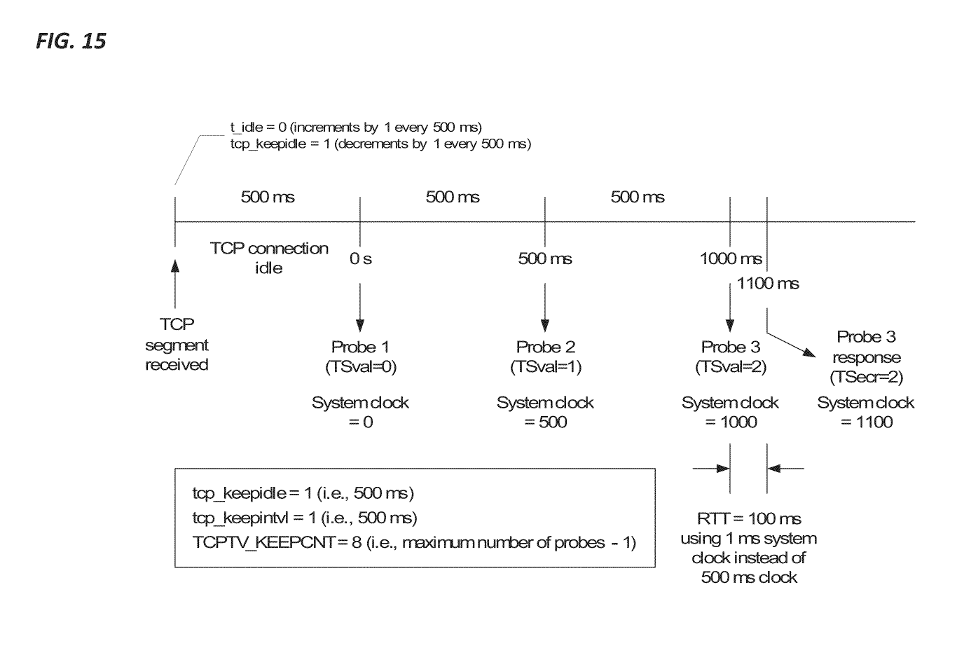

If tcp_now is tied to a 500 ms clock, however, RTTs are measured in multiples of 500 ms. In order to provide higher resolution RTT measurements, tcp_now can be tied to the 1 ms system clock instead, wherein RTT estimates are calculated by recording the system clock when a TCP data segment is transmitted, and then reading the system clock when the corresponding ACK is received. In FIG. 15, an exemplary timeline is provided in which a timestamp option is utilized in conjunction with a 1 ms system clock to estimate RTT (shown with respect to probe 3).

### Exemplary Procedure for Estimating Round Trip Time

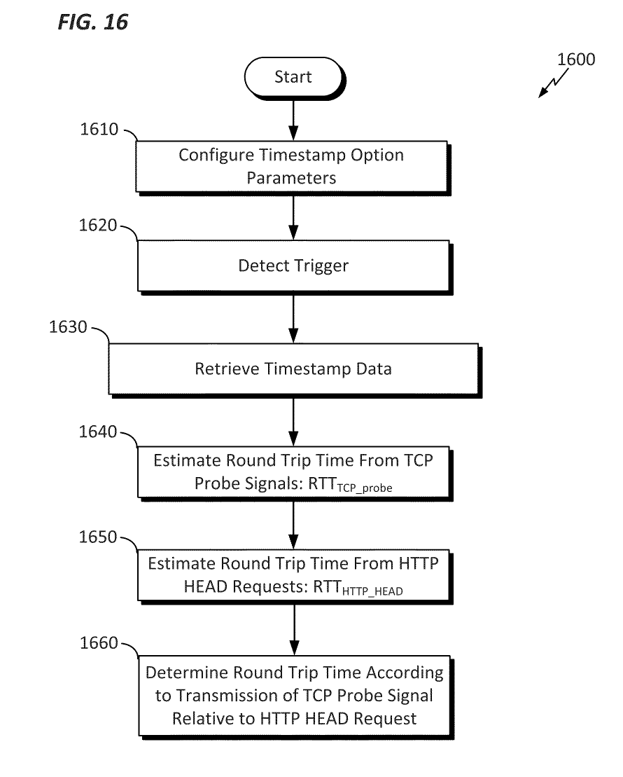

Referring next to FIG. 16, a flowchart illustrating an exemplary procedure for estimating round trip time by utilizing a TCP timestamps option in accordance with an aspect of the disclosure is provided. As illustrated, procedure 1600 comprises a series of acts that facilitate estimating round trip time by utilizing a TCP timestamps option, wherein such acts may be performed in conjunction with other aspects disclosed herein. For instance, with reference to FIG. 2, it is contemplated that block 204 of procedure 200 may comprise transmitting probe signals in conjunction with a TCP timestamps option according to aspects of procedure 1600. The accuracy of the round trip estimate subsequently performed at block 208 may then be improved by utilizing timestamp option data ascertained according to aspects of procedure 1600. To this end, it is contemplated that procedure 1600 may be performed at a UE, such as UE 100 of FIG. 1, by any combination of hardware and/or software included therein. For instance, procedure 1600 may be performed by any combination of estimate circuit 140 and/or receive instructions 106c.

As illustrated, procedure 1600 begins at block 1610 where various timestamp option parameters are configured. Such parameters may, for example, include tying tcp_now to the 1 ms system clock instead of the 500 ms clock, as indicated above, wherein timestamp option configurations are facilitated by timestamp sub-circuit 1120 and/or timestamp instructions 1122. A trigger for performing an RTT estimate after transmitting a TCP probe signal is then detected at block 1620, which may include any of the aforementioned triggers mentioned above (e.g., establishment of a TCP connection, threshold number of acknowledgment signals, etc.). Procedure 1600 then proceeds to block 1630 where timestamp data associated with each received acknowledgment is retrieved.

Upon receiving TCP acknowledgments and retrieving their corresponding timestamp data, the UE may estimate the RTT (viz. RTT_{TCP}_{_{—}}_{probe}) between the UE and the proxy server (if one is present) or origin server at block 1640. Similarly, upon receiving HTTP HEAD request responses and retrieving their corresponding timestamp data, the UE may estimate the RTT (viz. RTT_{HTTP}_{_{—}}_{HEAD}) between the UE and the origin server at block 1650. Procedure 1600 then concludes at block 1660 where the UE determines the total RTT based on whether the TCP probe signal was transmitted concurrently with the HTTP HEAD request. For instance, if the TCP probe signal and HTTP HEAD request were transmitted at the same time, then RTT_{Total}=RTT_{HTTP}_{_{—}}_{HEAD} and a delta between RTT_{HTTP}_{_{—}}_{HEAD} and RTT_{TCP}_{_{—}}_{probe} is calculated for future reference, where Δ=RTT_{HTTP}_{_{—}}_{HEAD}−RTT_{TCP}_{_{—}}_{probe}. However, if the TCP probe signal is not transmitted concurrently with the HTTP HEAD request, then RTT_{Total}=RTT_{TCP}_{_{—}}_{probe}+Δ, where the value for Δ is from the last time that the TCP probe signal and HTTP HEAD request were transmitted at the same time.

Several aspects of a telecommunications system have been presented with reference to particular systems. As those skilled in the art will readily appreciate, various aspects described throughout this disclosure may be extended to other telecommunication systems, network architectures and communication standards.

By way of example, various aspects may be extended to other UMTS systems such as TD-SCDMA and TD-CDMA. Various aspects may also be extended to systems employing LTE (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first die may be coupled to a second die in a package even though the first die is never directly physically in contact with the second die. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-16 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-16 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of a, b, or c” is intended to cover: one or more a; one or more b; one or more c; one or more a and one or more b; one or more a and one or more c; one or more b and one or more c; and one or more a, one or more b, and one or more c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication comprising:
facilitating establishing a plurality of transmission control protocol (TCP) connections across multiple radio access technologies between a client and a server, wherein each radio access technology is associated with at least one of the plurality of TCP connections;
selecting at least one TCP connection of the plurality of TCP connections for each of the multiple radio access technologies;
transmitting at least one probe signal from the client to the server over the selected at least one TCP connection;
receiving at least one acknowledgment signal at the client from the server via the selected at least one TCP connection, wherein the at least one acknowledgment signal is a TCP acknowledgment signal received in response to the at least one probe signal; and
estimating a round trip time between the client and the server based on the at least one probe signal and the at least one acknowledgment signal.

2. The method of claim 1, further comprising retrieving timestamp data from a TCP timestamps option, wherein the estimating of the round trip time is performed as a function of the timestamp data.

3. The method of claim 2, wherein the TCP timestamps option comprises a Timestamp Value field, and wherein the Timestamp Value field includes a timestamp clock value at the server.

4. The method of claim 1, wherein the selected at least one TCP connection is an idle TCP connection.

5. The method of claim 4, wherein the facilitating comprises respectively establishing a single TCP connection for each of the multiple radio access technologies, wherein the selecting comprises selecting a particular single TCP connection as the selected at least one TCP connection, and wherein subsequent probe signals and corresponding acknowledgment signals are communicated via the particular single TCP connection when the particular single TCP connection is idle.

6. The method of claim 4, wherein the facilitating comprises respectively establishing at least two TCP connections for each of the multiple radio access technologies, wherein the selecting comprises rotating the selected at least one TCP connection amongst the plurality of TCP connections, and wherein subsequent probe signals and corresponding acknowledgment signals are respectively communicated via the rotated selected TCP connection.

7. The method of claim 1, wherein the at least one probe signal is at least one of a TCP keepalive signal or an HTTP HEAD request.

8. The method of claim 1, wherein the at least one probe signal comprises a first probe signal and a second probe signal, the first probe signal being a TCP keepalive signal, and the second probe signal being an HTTP HEAD request.

9. The method of claim 8, wherein the transmitting comprises determining a frequency of the TCP keepalive signal and a frequency of the HTTP HEAD request, and wherein the frequency of the TCP keepalive signal is larger than the frequency of the HTTP HEAD request.

10. The method of claim 8, wherein the receiving comprises:
receiving an acknowledgment of the TCP keepalive signal from a proxy server; and
receiving an acknowledgment of the HTTP HEAD request from an origin server via the proxy server.

11. The method of claim 10, wherein the estimating comprises estimating a total round trip time based on the acknowledgment of the TCP keepalive signal and the acknowledgment of the HTTP HEAD request.

12. The method of claim 1, wherein the estimating is triggered upon detecting that a predetermined number of acknowledgment signals have been received.

13. The method of claim 1, wherein the estimating is triggered upon detecting that a TCP connection has been established.

14. A device comprising:
a transmit circuit configured to facilitate establishing a plurality of transmission control protocol (TCP) connections across multiple radio access technologies between a client and a server, wherein each radio access technology is associated with at least one of the plurality of TCP connections, the transmit circuit further comprising a TCP selection subcircuit configured to select at least one TCP connection of the plurality of TCP connections for each of the multiple radio access technologies, wherein the transmit circuit is configured to transmit at least one probe signal from the client to the server over the selected at least one TCP connection;
a receive circuit configured to receive at least one acknowledgment signal at the client from the server via the selected at least one TCP connection, wherein the at least one acknowledgment signal is a TCP acknowledgment signal received in response to the at least one probe signal; and
an estimate circuit configured to estimate a round trip time between the client and the server based on the at least one probe signal and the at least one acknowledgment signal.

15. The device of claim 14, wherein the estimate circuit further comprises a timestamp subcircuit configured to ascertain timestamp data from a TCP timestamps option, and wherein the estimate circuit is configured to estimate the round trip time as a function of the timestamp data.

16. The device of claim 15, wherein the TCP timestamps option comprises a Timestamp Value field, and wherein the Timestamp Value field includes a timestamp clock value at the server.

17. The device of claim 14, wherein the selected at least one TCP connection is an idle TCP connection.

18. The device of claim 17, wherein the TCP selection subcircuit is configured to respectively establish a single TCP connection for each of the multiple radio access technologies and select a particular single TCP connection as the selected TCP connection, and wherein subsequent probe signals and corresponding acknowledgment signals are communicated via the particular single TCP connection when the particular single TCP connection is idle.

19. The device of claim 17, wherein the TCP selection subcircuit is configured to respectively establish at least two TCP connections for each of the multiple radio access technologies and rotate the selected TCP connection amongst the plurality of TCP connections, and wherein subsequent probe signals and corresponding acknowledgment signals are respectively communicated via the rotated selected TCP connection.

20. The device of claim 14, wherein the transmit circuit further comprises a probe selection subcircuit configured to select a probe signal type associated with the probe signal.

21. The device of claim 20, wherein the probe selection circuit is configured to select at least one of a TCP keepalive signal or an HTTP HEAD request as the probe signal.

22. The device of claim 21, wherein the transmit circuit is configured to transmit a first probe signal and a second probe signal, wherein the probe selection circuit is configured to select a TCP keepalive signal for the first probe signal, and wherein the probe selection circuit is configured to select an HTTP HEAD request for the second probe signal.

23. The device of claim 14, wherein the estimate circuit further comprises a trigger circuit configured to trigger an estimation of the round trip time upon detecting that a predetermined number of acknowledgment signals have been received.

24. The device of claim 14, wherein the estimate circuit further comprises a trigger circuit configured to trigger an estimation of the round trip time upon detecting that a TCP connection has been established.

25. A non-transitory machine-readable storage medium having one or more instructions stored thereon, which when executed by at least one processor causes the at least one processor to:
facilitate establishing a plurality of transmission control protocol (TCP) connections across multiple radio access technologies between a client and a server, wherein each radio access technology is associated with at least one of the plurality of TCP connections;
select at least one TCP connection of the plurality of TCP connections for each of the multiple radio access technologies;
transmit at least one probe signal from the client to the server over the selected at least one TCP connection;
receive at least one acknowledgment signal at the client from the server via the selected at least one TCP connection, wherein the at least one acknowledgment signal is a TCP acknowledgment signal received in response to the at least one probe signal; and
estimate a round trip time between the client and the server based on the at least one probe signal and the at least one acknowledgment signal.

26. The non-transitory machine-readable storage medium of claim 25, wherein the one or more instructions further comprise instructions, which when executed by the at least one processor cause the at least one processor to:
ascertain timestamp data from a TCP timestamps option; and
estimate the round trip time as a function of the timestamp data.

27. The non-transitory machine-readable storage medium of claim 25, wherein the at least one probe signal comprises a first probe signal and a second probe signal, the first probe signal being a TCP keepalive signal, and the second probe signal being an HTTP HEAD request.

28. A device comprising:
means for transmitting configured to facilitate establishing a plurality of transmission control protocol (TCP) connections across multiple radio access technologies between a client and a server, wherein each radio access technology is associated with at least one of the plurality of TCP connections, wherein at least one TCP connection of the plurality of TCP connections is selected for each of the multiple radio access technologies, the means for transmitting further configured to transmit at least one probe signal from the client to the server over the selected at least one TCP connection;
means for receiving at least one acknowledgment signal at the client from the server via the selected at least one TCP connection, wherein the at least one acknowledgment signal is a TCP acknowledgment signal received in response to the at least one probe signal; and
means for estimating a round trip time between the client and the server based on the at least one probe signal and the at least one acknowledgment signal.

29. The device of claim 28, wherein the means for estimating further comprises a means for triggering an estimation of the round trip time upon detecting that a predetermined number of acknowledgment signals have been received.

30. The device of claim 28, wherein the means for estimating further comprises a means for triggering an estimation of the round trip time upon detecting that a TCP connection has been established.
